(19) United States
(12) Patent Application Publication
(10) Pub. No.: US 2026/0312206 A1
(43) Pub. Date: Oct. 8, 2026

(54) BATTERY MODULE SYSTEM FOR MOBILE POWER STATION

(71) Applicant: MOXION POWER CO., Richmond, CA (US)

(72) Inventors: Edward P. YANKOSKI, West Branch, MI (US); Alexander J. SMITH, Lakeside, CA (US)

(73) Assignee: MOXION POWER CO., Richmond, CA (US)

(21) Appl. No.: 19/484,246

(22) PCT Filed: May 15, 2024
(86) PCT No.: PCT/US2024/029520

§ 371 Date: Nov. 13, 2025

Related U.S. Application Data
(60) Provisional application No. 63/502,353, filed on May 15, 2023.

(51) Int. Cl. H01M 50/251; H01M 10/658; H01M 50/213; H01M 50/367; H01M 50/507

(52) U.S. Cl. CPC H01M 50/251; H01M 10/658; H01M 50/213; H01M 50/367; H01M 50/507; H01M 2220/10

(57) ABSTRACT

Mobile power unit systems and methods are disclosed. The apparatus and system can include two or more conductor assemblies disposed on at least two different sides of a plurality of battery cells. The conductor assemblies can be electrically coupled to a plurality of cells disposed within a battery housing assembly. The battery housing assembly can comprise first and second assemblies comprising a plurality of openings configured to receive the battery cells. The battery housing assembly can comprise a plastic material.

### PRIORITY CLAIM

This patent application claims priority to U.S. provisional patent application No. 63/502,353, titled “BATTERY MODULE SYSTEM FOR MOBILE POWER STATION,” and filed on May 15, 2023, which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The present application relates generally to all-electric, portable industrial power generators which provide temporary on-site power to industries such as construction, film, entertainment, power and utility, electric vehicles, and telecom. More specifically, this disclosure provides a battery module for use with portable power generators that include an embedded heating capability.

### BACKGROUND

Temporary electrical power systems are typically used in scenarios in which access to the electrical grid does not exist at a particular site or when the existing electrical grid does not satisfy the power requirements of the site. Examples include construction sites, mining sites, manufacturing sites, shipping locations, areas impacted by natural disasters, temporary event locations, electric vehicle charging, and others (e.g., such as military installations, telecom sites, and residential locations).

All-electric, portable industrial power generators may be used to provide temporary electrical power in cases when traditional internal combustion generators are not desired or cannot be used due to site specific or user specific requirements. The all-electric industrial power generators may rely on a plurality of batteries to provide stored energy that may be converted into alternating current (AC) power on demand.

Battery modules for automotive and off highway applications require highly robust structures to manage shock loads, long term vibration, thermal extremes and amongst other things cell expansion and contraction over time. Battery modules are generally connected via a welded, bolted, clamped or other interlocking connection mechanism and require attaching flanges or other retention mechanism. Generally, what limits the use of plastics in these applications is the difficulty in meeting stringent industry standards for shock, vibration and drop testing.

### SUMMARY OF THE DISCLOSURE

Described herein are apparatuses, systems, and methods to control temperatures of battery cells, particularly battery cells use with mobile power units designed to provide alternating current power at job sites, construction zones, temporary facilities, disaster relief, or the like.

A battery module is provided, comprising: a first battery housing assembly comprising a first plurality openings; a second battery housing assembly comprising a second plurality of openings; a plurality of battery cells disposed at least partially in the first plurality of openings of the first battery housing assembly and the second plurality of openings of the second battery housing assembly; a first current collector disposed along an outside surface of the first battery housing assembly, the first current collector being configured to electrically couple together two or more terminals on a first side of the plurality of battery cells; and a second current collector disposed along an outside surface of the second battery housing assembly, the second current collector being configured to electrically couple together two or more terminals on a second side of the plurality of battery cells.

In some aspects, the first and second plurality of openings are sized and configured to an outer diameter of the plurality of battery cells.

In one aspect, the first and second battery housing assemblies comprise a plastic material.

In some aspects, the module includes a front battery housing assembly and a rear battery housing assembly, wherein the front battery housing assembly is coupled to the first and second battery housing assemblies and the rear battery housing assembly is coupled to the first and second battery assemblies.

In some aspects, the front and rear battery housing assemblies are coupled to the first and second battery assemblies with one or more attachment mechanisms.

In other aspects, the one or more attachment mechanisms comprise tabs or fingers configured to extend into slots or recesses of the first and second battery housing assemblies.

In some aspects, the front and rear battery housing assemblies are coupled to the first and second battery assemblies with an adhesive to form an exoskeleton around the plurality of battery cells.

In some aspects, the module includes a plurality of standoffs disposed on an exterior surface of the first and second battery housing assemblies.

In one aspect, the standoffs are configured to provide alignment between the first and second battery housing assemblies and the first and second current collectors, respectively.

In some aspects, the plurality of standoffs extend through the first and second current collectors.

In other aspects, the battery module includes first and second thermal barriers disposed on the first and second current collectors, respectively.

In some aspects, the first and second thermal barriers include venting gas cutouts configured to send, route, or direct gasses in a direction perpendicular to an exterior surface of the first and second thermal barriers.

In other aspects, the battery modules include a plurality of standoffs disposed on an exterior surface of the first and second battery housing assemblies.

In some aspects, the standoffs are configured to provide alignment between the first and second battery housing assemblies and the first and second current collectors and the first and second thermal barriers.

In other aspects, the plurality of standoffs extend through the first and second current collectors and through the first and second thermal barriers.

In some aspects, the battery modules include first and second bus plates disposed on the front battery housing assembly.

In some aspects, the first and second bus plates are electrically coupled to the first and second current collectors, respectively.

A battery module is provided, comprising: a first battery housing assembly comprising a first plurality openings; a second battery housing assembly comprising a second plurality of openings; a front battery housing assembly coupled to the first and second battery housing assemblies; a rear battery housing assembly coupled to the first and second battery housing assemblies, wherein the first battery housing assembly, the second battery housing assembly, the front battery housing assembly, and the rear battery housing assembly form a central cavity; and a plurality of battery cells disposed in the cavity and supported at least partially by the first plurality of openings of the first battery housing assembly and the second plurality of openings of the second battery housing assembly.

In some aspects, the first battery housing assembly, the second battery housing assembly, the front battery housing assembly, and the rear battery housing assembly are formed from a heat-resistant plastic.

In another aspect, a diameter of the first and second plurality of openings is configured to receive an outer diameter of the plurality of battery cells.

In some aspects, the battery module includes a first current collector disposed along an outside surface of the first battery housing assembly, the first current collector being configured to electrically couple together two or more terminals on a first side of the plurality of battery cells; and a second current collector disposed along an outside surface of the second battery housing assembly, the second current collector being configured to electrically couple together two or more terminals on a second side of the plurality of battery cells.

In some aspects, first and second bus plates are disposed on the front battery housing, the first and second bus plates being electrically coupled to the first and second current collectors, respectively.

In one aspect, the front and rear battery housing assemblies are coupled to the first and second battery assemblies with one or more attachment mechanisms.

In some aspects, the one or more attachment mechanisms comprise tabs or fingers configured to extend into slots or recesses of the first and second battery housing assemblies.

In some aspects, the front and rear battery housing assemblies are coupled to the first and second battery assemblies with an adhesive to form an exoskeleton around the plurality of battery cells.

In some aspects, the battery modules include a plurality of standoffs disposed on an exterior surface of the first and second battery housing assemblies.

In some aspects, the battery modules have a plurality of standoffs disposed on an exterior surface of the first and second battery housing assemblies.

In some examples, the standoffs are configured to provide alignment between the first and second battery housing assemblies and the first and second current collectors, respectively.

In other examples, the plurality of standoffs extend through the first and second current collectors.

In some aspects, the battery modules include first and second thermal barriers disposed on the first and second current collectors, respectively.

In some aspects, the first and second thermal barriers include venting gas cutouts configured to send, route, or direct gasses in a direction perpendicular to an exterior surface of the first and second thermal barriers.

In some aspects, the battery modules include a plurality of standoffs disposed on an exterior surface of the first and second battery housing assemblies.

In some aspects, the standoffs are configured to provide alignment between the first and second battery housing assemblies and the first and second thermal barriers.

In one aspect, the plurality of standoffs extend through the first and second current collectors and through the first and second thermal barriers.

A mobile power unit is provided, comprising: an exterior housing; an energy storage system rack structure disposed within the exterior housing, the energy storage system rack structure being configured to hold and support a plurality of battery modules, each battery module comprising: a first battery housing assembly comprising a first plurality openings; a second battery housing assembly comprising a second plurality of openings; a front battery housing assembly coupled to the first and second battery housing assemblies; a rear battery housing assembly coupled to the first and second battery housing assemblies, wherein the first battery housing assembly, the second battery housing assembly, the front battery housing assembly, and the rear battery housing assembly form a central cavity; a plurality of battery cells disposed in the cavity and supported at least partially by the first plurality of openings of the first battery housing assembly and the second plurality of openings of the second battery housing assembly; a first current collector disposed along an outside surface of the first battery housing assembly, the first current collector being configured to electrically couple together two or more terminals on a first side of the plurality of battery cells; and a second current collector disposed along an outside surface of the second battery housing assembly, the second current collector being configured to electrically couple together two or more terminals on a second side of the plurality of battery cells.

In some aspects, one or more outlets are disposed on or in the exterior housing, the one or more outlets being configured to provide a desired voltage and phase configuration from the plurality of battery modules to an attached electrical load.

In one aspect, the mobile power unit includes one or more system controllers, processors, and associated circuitry disposed in the housing and configured to deliver energy having the desired voltage and phase configuration to the one or more outlets.

In some aspects, each battery module further comprises first and second thermal barriers disposed on the first and second current collectors.

In one aspect, the first and second thermal barriers of each battery module include venting gas cutouts configured to send, route, or direct gasses in a direction perpendicular to adjacent battery modules.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is a view of an example mobile power unit.

FIGS. 2A-2B show on embodiment of a battery module of a mobile power unit.

FIG. 3 is a side-view of a battery assembly of a battery module.

FIG. 4 is a side-view of a battery module including a thermal barrier.

FIG. 5 is a view of a mobile power unit.

### DETAILED DESCRIPTION

In general, all-electric, portable, industrial power generators include one or more battery cells to provide stored energy that may be converted into electrical AC or DC power. The industrial power generator may use several battery cells to supply sufficient electrical capacity and/or voltage for any DC/DC converters, power inverters, or any other associated circuitry. The battery cells themselves can be removably mounted or affixed into a receiving frame within the industrial power generators.

Battery modules for automotive and off highway applications typically require highly robust exoskeletal structures to manage severe shock loads, long term vibration, thermal extremes, propagation strategies and amongst other things cell expansion and contraction over time. Battery modules are generally connected via a welded, bolted, clamped, bonded or other interlocking connection mechanism and require attaching flanges or other retention mechanism.

It is an object of the present disclosure to provide battery modules designed to provide constant power and energy over the full range of the battery cells voltage. The designs of the present disclosure offer high energy density along with uncompromising structural integrity. Included features are simple, low cost, repeatable and optimized for on, off road or stationary applications. This system and battery modules are designed to work over a wide range of voltages and power levels with minimal temperature gradients at the extreme (corner case) usage profiles. The battery modules of the present disclosure can also include one or more thermal layers configured to minimize the opportunity for thermal propagation under unintended usage.

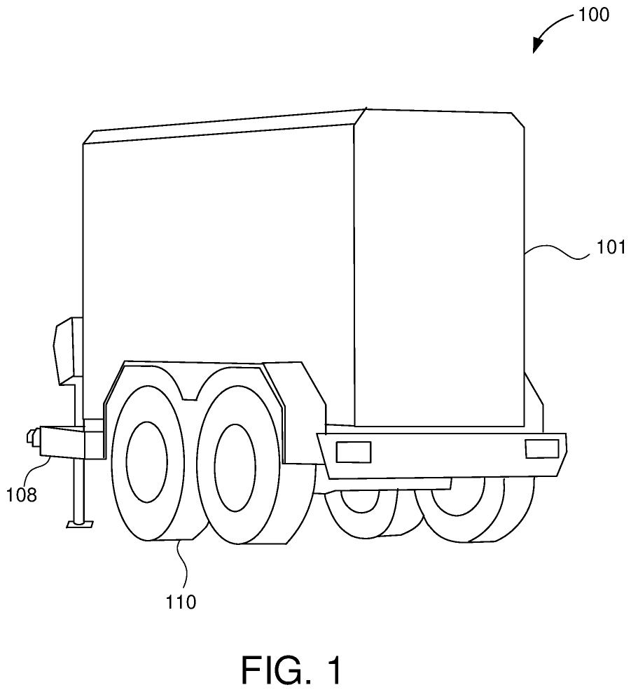

FIG. 1 is a view of an example mobile power unit 100. The mobile power unit 100 may be an all-electric or hybrid power unit configured to provide alternating current (AC) and/or direct current (DC) power on demand for any feasible use. In some embodiments, the desired electrical output is chosen by the user from a pre-selected group of common electrical outputs (e.g., 480VAC 3-Phase, 208VAC 3-Phase, 240VAC 1-Phase, 120VAC 1-Phase or the like). In another embodiment, the user can select any desired output voltage amplitude, frequency, and phase shift, allowing the mobile power unit to provide any user-selected electrical output. The mobile power unit 100 can further be configured to provide a regulated DC output (e.g., for electric vehicle charging). In some embodiments, the mobile power unit 100 may be controlled through an integrated control panel or through a GUI implemented on a remote device, such as a smartphone, tablet, or PC, which can be configured to communicate with the mobile power unit via wireless technologies such as Bluetooth, Wi-Fi, cellular, etc.

The mobile power unit 100 can include an electrical energy source (not shown) disposed within a housing 101. In one configuration, the electrical energy source comprises a plurality of lithium-ion battery cell groups arranged in series connections. In other embodiments, the electrical energy source can comprise other known energy storage devices, such as ultracapacitors or fuel cells. While lithium-ion is presently the preferred battery cell type, it should be understood that other battery cells can be used in place of lithium-ion cells as battery technology evolves. In some examples, the electrical energy source can have an operating voltage range of 300-450 volts. In other embodiments, the electrical energy source can have a higher operating voltage range of 450-1000 volts.

The mobile power unit 100 can include a trailer 108 configured to attach to a trailer hitch or tow vehicle, and a plurality of wheels 110 which allow for easy of transportation and delivery of the mobile power unit to remote sites. The size of the mobile power unit 100 can vary depending on electrical output and energy storage capabilities, but in general, the mobile power unit 100 itself can range in size from approximately 50″ long, 30″ wide, and 50″ tall up to 150″ long, 60″ wide, and 60″ tall. The trailer can add an extra 50-70″ in length and 20-30″ in height depending on the size and weight of the mobile power unit 100 and the number and size of wheels required to carry the weight of the mobile power unit 100. In a preferred embodiment, the mobile power unit 100 is approximately 100″ long, 40″ wide, and 60″ tall, with the trailer adding an additional 40-50″ in length and 15-30″ in height. In other embodiments, the mobile power unit can be scaled up or down in terms of operating voltage range and outputs, and the size of the mobile power unit 100 can be adjusted accordingly.

The mobile power unit described herein may be configured to house, support, transport, etc. rechargeable electric power systems comprising one or more components and connections. For example, the mobile power unit can include an electrical energy source which can comprise, for example, a plurality of battery cells. The electrical energy source can be electrically connected to a power distribution unit (PDU), which includes a plurality of electrical inputs and outputs configured to distribute electrical power throughout the mobile power unit. The mobile power unit can include additional electrical components, such as a battery management system (BMS), one or more system controllers or processors, electrical connections, inverter stages, power convertors, etc., the details of which are described in related pending applications but is beyond the scope of this disclosure. In general, the electrical components of the mobile power unit are configured to deliver energy having a desired voltage and phase configuration to one or more outputs on the mobile power unit. Additional details can be found in U.S. Pat. No. 11,283,273, incorporated herein by reference in its entirety, includes additional details on one or more system controllers, processors, and associated circuitry which is configured to deliver energy having a desired voltage and phase configuration to one or more outputs on the mobile power unit.

In some examples, any, all or none of the electrical components and connections may be coupled to or in communication with the mobile power unit trailer systems described herein.

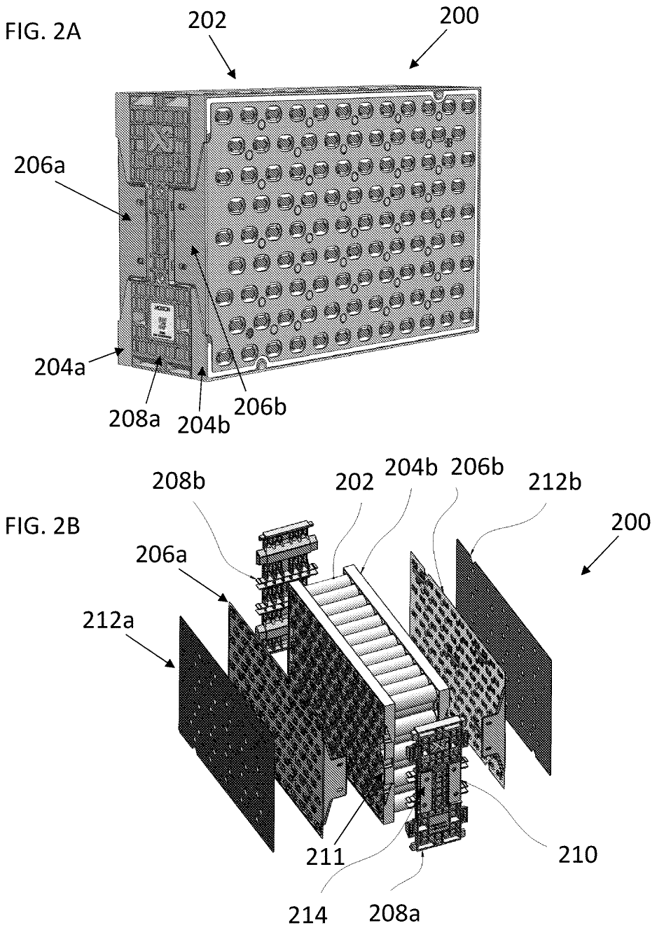

FIGS. 2A-2B show isometric and exploded views, respectively, of an example battery module or housing 200. The battery module 200 can be used to house, protect, and mount any feasible battery cell within a mobile power unit. In some examples, the battery module 200 may be used to affix one or more batteries 202 (battery cells) within the mobile power unit. As used herein, the terms battery and battery cells are interchangeable and can describe any feasible energy storage unit, device, or the like. The battery cells can include any number of batteries that are interconnected in a parallel and/or serial fashion to provide an input voltage to the electronics of the mobile power unit. The battery modules of the present disclosure generally have the shape of a rectangular prism, however other shapes (e.g., cube, etc.) are contemplated. The battery module 200 may include a battery housing that partially or completely surrounds, and is securely attached to, the battery cells.

In the illustrated embodiment, the battery module 200 can include a housing that comprises a first battery housing assembly 204a and a second battery housing assembly 204b. The batteries of the battery module may be sandwiched or placed between the first and second battery housing assemblies 204a and 204b. For example, the negative terminals of the batteries may be placed within the first battery housing assembly 204a, and the positive terminals of the batteries may be placed within the second battery housing assembly 204b.

In some variations, the battery housing may surround four sides of the battery. For example, the battery housing may further include front battery housing assembly 208a and rear battery housing assembly 208b. In some implementations, the front and rear battery housing assemblies may include engagement, interlocking, or attachment features 210. The attachment features 210 may be configured to engage with corresponding features 211 on the first and second battery housing assemblies 204a and 204b. In the illustrated embodiment, the attachment features 210 comprise clips, tabs, or fingers that are configured to be inserted into receiving features in the the first and second battery assemblies. For example, any interference fit or permanent/semi-permanent fixation techniques including screws, nails, or adhesive can be used to hold or bond the front and rear battery assemblies to the side (first and second) battery assemblies. Other types of attachment or engagement features known in the art are within the scope of this disclosure. The components of the battery housing may be further attached or coupled together with adhesive to further strengthen the bond between the first, second, front, and rear battery assemblies. Adhesive bonding between the first, second, front, and rear battery assemblies provides a full “cage” like exoskeleton adding to the overall battery module robustness.

The battery housing, including the first, second, front, and rear battery housing assemblies, can be formed from heat-resistant plastic, extruded or machined metals, or a combination of any of these materials.

The battery module can include a pair of bus bars or bus plates 214 configured to interface with first and second current collectors 206a and 206b which act as electrical conductors for current to flow to and from the battery cells within the battery module. In the embodiment of FIGS. 2A-2B, the bus plates 214 are disposed on the front battery housing assembly 208a. However, it should be understood that these bus plates can be disposed on any of the battery assemblies. In this example, the first current collector 206a can be a negative current collector and the second current collector 206b can be a positive current collector. Although two current collectors are shown in this embodiment, it should be understood that any number of current collectors can be implemented. The bus plates 214 in this embodiment are positioned on the front battery housing assembly 208a. However, it should be understood that the bus plates can be located anywhere on the battery housing, including on the first, second, front, or rear battery housing assemblies.

FIG. 2B shows optional battery thermal barriers 212a and 212b. The thermal barriers can comprise non-conductive materials configured to isolate or reduce the amount of heat transferred between adjacent battery modules. Additionally the thermal barriers can be configured to vent gas and prevent escaping gasses and ejecta from reaching neighboring battery modules. In the illustrated embodiment, the thermal barriers are placed on an outside surface of the current collectors. The thermal barriers provide a tortuous path for venting gasses. In the unlikely event of a thermal runaway incident, the thermal barrier layer includes trapezoidal cutouts that create a deflection path for pressurized gasses and ejecta.

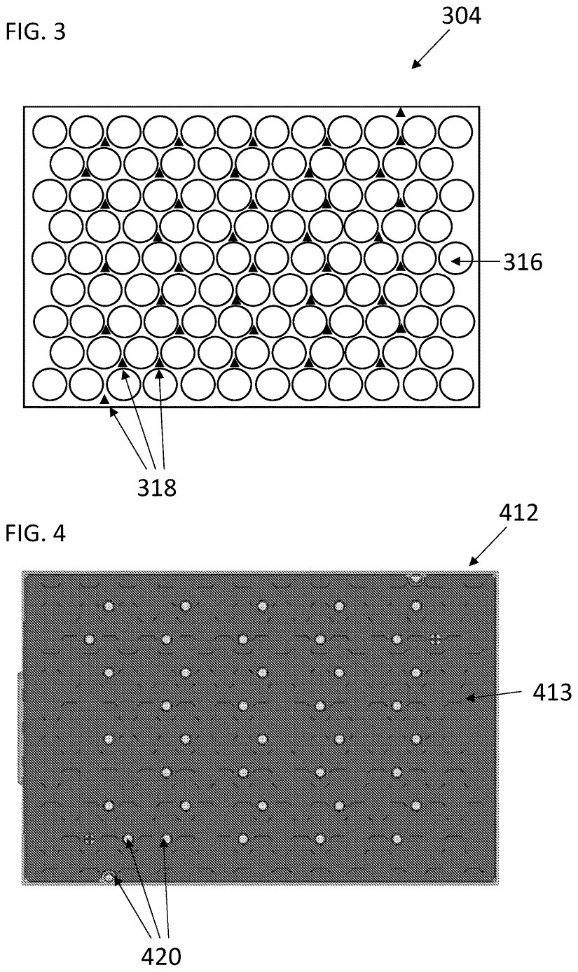

FIG. 3 is a side view of a battery housing assembly 304 of a battery module. The battery housing assembly 304 shown in FIG. 3 can correspond with, for example, the first battery housing assembly 204a or second battery housing assembly 204b of FIGS. 2A-2B.

The battery housing assembly 304 can include a plurality of openings 316, corresponding to the number of batteries in the battery module. The openings can have a diameter that is sized and configured to conform with or provide tight tolerances with the outer diameter of the battery cells being used. In some embodiments, the openings 316 include a stop or cell end face that prevents passage of the battery cells through the openings and through the battery housing assembly. For example, the opening can include a first diameter configured to receive the battery cells and a second diameter configured to prevent the cells from passing through the openings but still allow for contact between the cells and the current collector(s). In some embodiments, the first (larger) diameter is positioned on an interior surface of the battery housing assembly, and the second (smaller) diameter is positioned on an exterior surface of the battery housing assembly. Alternatively, the openings can include a stop or end face on the exterior surface of the opening to prevent complete passage of battery cells through the opening. The openings can be placed to optimize cell spacing and avoid less than desirable cell spacing (e.g., avoid less than 1.5 mm spacing between cells) to allow for proper heat distribution and equal thermal mass.

The battery housing assembly 304 can further include one or more standoffs 318 protruding from an exterior surface of the assembly. The standoffs can be configured to support the battery module when it is laid on its side to prevent damage to the current collectors and/or thermal barriers of the battery module (e.g., when the battery module is laid on its side on a surface, the standoffs contact the surface instead of the thermal barriers/current collectors. In some embodiments, the standoffs are long enough to pass through one or more current collectors and/or thermal barriers. The standoffs can be distributed throughout the openings 316 of the assembly.

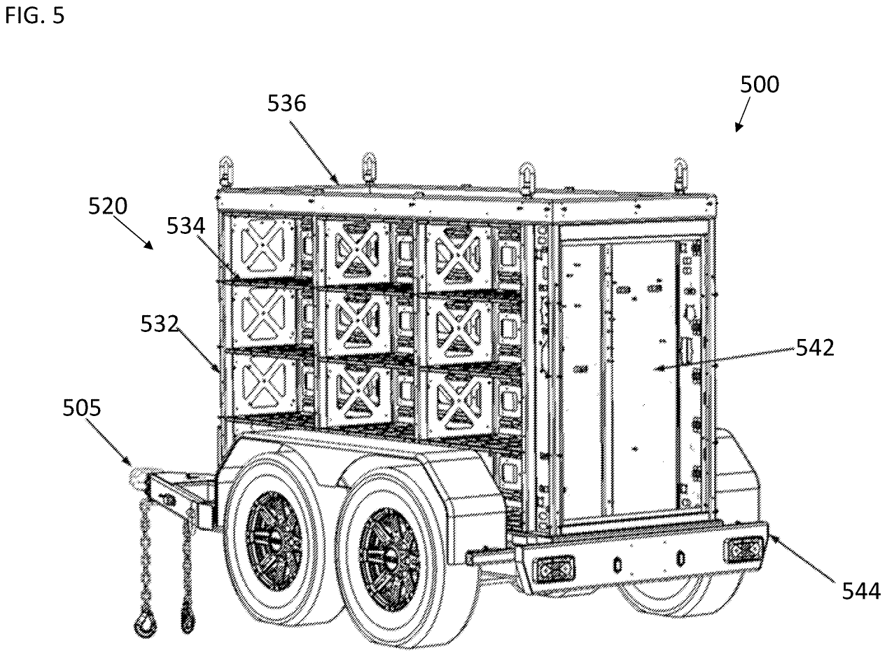

In one embodiment, the standoffs of the battery housing assembly provide alignment between the battery housing assembly and the current collectors and thermal barriers. For example, referring to FIG. 4, the thermal barriers 412 and/or current collectors can include holes or openings 420 that align with the standoffs 318 of the battery housing assembly. The holes allow for precise alignment between the current collector, thermal barriers, and the battery housing assembly, while also allowing the standoffs of the battery assemblies to extend through the current collectors and thermal barriers to prevent damage to those components if the battery module is laid on its side. Additionally, the thermal barriers 412 and/or the current collectors can include venting gas cutouts 413 configured to send, route, or direct gasses in a direction perpendicular to the surface of the thermal barriers and/or battery housing assemblies, and therefore perpendicular to any opposing battery cells/modules. Therefore, the venting gas cutouts are configured to cause gas or heat to flow parallel to the surface of the battery module (e.g., along the face of the battery assemblies 204a and 204b above) and not perpendicular to the battery assemblies, thereby preventing the heat and gas from being directed towards adjacent battery modules.

FIG. 5 illustrates an example of a mobile power unit 500 with sidewalls removed to expose internal detail of the housing 520. In this view, the mobile power unit includes a trailer frame 505, a rechargeable energy storage system rack structure 532, battery module shelves 534, top tubular surround structure 536, and rear bumper 544. The individual battery units or battery modules described above can be housed in the rack structure 532, each battery unit or module being supported by a battery module shelf 534. Here, the top tubular surround structure 536 is configured to provide a frame for housing many electrical components of the mobile power unit, such as the inverters, BMS, PDU, etc. described above.

Referring to FIG. 5, rear access panel 542 may be positioned within the housing 520. The rear access panel can provide user access to one or more electrical outputs of the mobile power unit (e.g., for connecting a load to the 480VAC 3-Phase, 208VAC 3-Phase, 240VAC 1-Phase, 120VAC 1-Phase, etc. electrical outputs. The rear access panel 542 can further provide access to one or more user panels, displays, or input devices, such as a graphical user input (GUI) device or display.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A battery module comprising:
a first battery housing assembly comprising a first plurality openings;
a second battery housing assembly comprising a second plurality of openings;
a plurality of battery cells disposed at least partially in the first plurality of openings of the first battery housing assembly and the second plurality of openings of the second battery housing assembly;
a first current collector disposed along an outside surface of the first battery housing assembly, the first current collector being configured to electrically couple together two or more terminals on a first side of the plurality of battery cells; and
a second current collector disposed along an outside surface of the second battery housing assembly, the second current collector being configured to electrically couple together two or more terminals on a second side of the plurality of battery cells.

2. The battery module of claim 1, wherein the first and second plurality of openings are sized and configured to an outer diameter of the plurality of battery cells.

3. (canceled)

4. The battery module of claim 1, further comprising a front battery housing assembly and a rear battery housing assembly, wherein the front battery housing assembly is coupled to the first and second battery housing assemblies and the rear battery housing assembly is coupled to the first and second battery assemblies.

5. The battery module of claim 4, wherein the front and rear battery housing assemblies
are coupled to the first and second battery assemblies with one or more attachment mechanisms, wherein the one or more attachment mechanisms
comprise tabs or fingers configured to extend into slots or recesses of the first and second battery housing assemblies.

6. (canceled)

7. (canceled)

8. The battery module of claim 1, further comprising a plurality of standoffs disposed on an exterior surface of the first and second battery housing assemblies.

9. (canceled)

10. The battery module of claim 9, wherein the plurality of standoffs extend through the first and second current collectors.

11. The battery module of claim 1, further comprising first and second thermal barriers disposed on the first and second current collectors, respectively.

12. The battery module of claim 11, wherein the first and second thermal barriers include venting gas cutouts configured to send, route, or direct gasses in a direction perpendicular to an exterior surface of the first and second thermal barriers.

13. The battery module of claim 11, further comprising a plurality of standoffs disposed on an exterior surface of the first and second battery housing assemblies.

14. (canceled)

15. The battery module of claim 13, wherein the plurality of standoffs extend through the first and second current collectors and through the first and second thermal barriers.

16. The battery module of claim 4, further comprising first and second bus plates disposed on the front battery housing assembly.

17. The battery module of claim 16, wherein the first and second bus plates are electrically coupled to the first and second current collectors, respectively.

18. A battery module comprising:
a first battery housing assembly comprising a first plurality openings;
a second battery housing assembly comprising a second plurality of openings;
a front battery housing assembly coupled to the first and second battery housing assemblies;
a rear battery housing assembly coupled to the first and second battery housing assemblies, wherein the first battery housing assembly, the second battery housing assembly, the front battery housing assembly, and the rear battery housing assembly form a central cavity; and
a plurality of battery cells disposed in the cavity and supported at least partially by the first plurality of openings of the first battery housing assembly and the second plurality of openings of the second battery housing assembly.

19. The battery module of claim 18, wherein the first battery housing assembly, the second battery housing assembly, the front battery housing assembly, and the rear battery housing assembly are formed from a heat-resistant plastic.

20. The battery module of claim 18, wherein a diameter of the first and second plurality of openings is configured to receive an outer diameter of the plurality of battery cells.

21. The battery module of claim 18, further comprising a first current collector disposed along an outside surface of the first battery housing assembly, the first current collector being configured to electrically couple together two or more terminals on a first side of the plurality of battery cells; and a second current collector disposed along an outside surface of the second battery housing assembly, the second current collector being configured to electrically couple together two or more terminals on a second side of the plurality of battery cells.

22. The battery module of claim 21, further comprising first and second bus plates disposed on the front battery housing, the first and second bus plates being electrically coupled to the first and second current collectors, respectively.

23. (canceled)

24. (canceled)

25. (canceled)

26. (canceled)

27. The battery module of claim 21, further comprising a plurality of standoffs disposed on an exterior surface of the first and second battery housing assemblies.

28. (canceled)

29. (canceled)

30. The battery module of claim 18, further comprising first and second thermal barriers disposed on the first and second current collectors, respectively.

31. The battery module of claim 30, wherein the first and second thermal barriers include venting gas cutouts configured to send, route, or direct gasses in a direction perpendicular to an exterior surface of the first and second thermal barriers.

32. (canceled)

33. (canceled)

34. (canceled)

35. (canceled)

36. (canceled)

37. (canceled)

38. (canceled)

39. (canceled)
